(19) United States
(12) Patent Application Publication
(10) Pub. No.: US 2025/0305323 A1
(43) Pub. Date: Oct. 2, 2025

(54) DOOR SYSTEM WITH LOCK ASSEMBLY

(71) Applicant: Master Lock Company LLC, Oak Creek, WI (US)

(72) Inventor: Aaron Treger, Pinole, CA (US)

(73) Assignee: Master Lock Company LLC, Oak Creek, WI (US)

(21) Appl. No.: 19/093,118

(22) Filed: Mar. 27, 2025

Related U.S. Application Data
(60) Provisional application No. 63/572,143, filed on Mar. 29, 2024.

(51) Int. Cl. E05B 63/00; E05B 9/04; E05B 47/00

(52) U.S. Cl. CPC E05B 63/0017; E05B 47/0012; E05B 2009/046; E05B 2047/0058

(57) ABSTRACT

A deadbolt assembly may be installed on a door defining a crossbore extending from a first face of the door to a second face of the door. The deadbolt assembly includes a deadbolt configured to engage a door frame to limit movement of the door, a lock assembly including a first housing and a lock cylinder configured to be coupled to the deadbolt, the first housing defining a first fastener aperture, a motor assembly including a second housing at least partially containing an electric motor configured to be coupled to the deadbolt, the second housing defining a second fastener aperture, and a fastener configured to extend into the first fastener aperture and the second fastener aperture to both (a) force the first housing against the first face of the door and (b) force the second housing against the second face of the door.

### CROSS-REFERENCE TO RELATED PATENT APPLICATION

This application claims the benefit of and priority to U.S. Provisional Application No. 63/572,143, filed on Mar. 29, 2024, the entire disclosure of which is hereby incorporated by reference herein.

### BACKGROUND

The present disclosure relates generally to systems for monitoring and controlling entry into a structure. More specifically, the present disclosure relates to a system for electronically controlling a door.

### SUMMARY

At least one embodiment relates to a deadbolt assembly for a door. The door defines a crossbore extending from a first face of the door to a second face of the door. The deadbolt assembly includes a deadbolt configured to engage a door frame to limit movement of the door, a lock assembly including a first housing and a lock cylinder configured to be coupled to the deadbolt, the first housing defining a first fastener aperture, a motor assembly including a second housing at least partially containing an electric motor configured to be coupled to the deadbolt, the second housing defining a second fastener aperture, and a fastener configured to extend into the first fastener aperture and the second fastener aperture to both (a) force the first housing against the first face of the door and (b) force the second housing against the second face of the door.

Another embodiment relates to a deadbolt assembly for a door. The deadbolt assembly includes a deadbolt, a lock assembly including a first housing and a lock cylinder, a motor assembly including a second housing at least partially containing an electric motor, a shaft configured to couple the lock assembly and the motor assembly to the deadbolt, a thumb turn assembly including a cover configured to be coupled to the motor assembly and a lever configured to be coupled to the shaft, and a battery configured to extend between the second housing of the motor assembly and the cover and configured to supply electrical energy to the electric motor.

Another embodiment relates to a door assembly including a door having a first face, a second face opposite the first face, and a crossbore extending from the first face to the second face. The crossbore has a diameter of approximately 2.125 inches. The door assembly further includes a deadbolt slidably coupled to the door, a deadbolt linkage coupled to the deadbolt and configured to reposition the deadbolt relative to the door, a lock assembly including a first housing engaging the first face of the door and a lock cylinder coupled to the first housing, the first housing defining a first fastener aperture, a motor assembly including a second housing engaging the second face of the door and an electric motor coupled to the second housing, the second housing defining a second fastener aperture, a fastener extending through the first fastener aperture and the second fastener aperture and coupling the first housing to the second housing, a cover coupled to the second housing of the motor assembly, a lever pivotably coupled to the cover, a shaft coupling the lock cylinder, the electric motor, and the lever to the deadbolt linkage, and a battery extending between the second housing of the motor assembly and the cover and configured to supply electrical energy to the electric motor. The motor assembly extends into the crossbore of the door.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a front view showing an exterior side of a door system, according to an exemplary embodiment.

FIG. 2 is a rear view showing an interior side of the door system of FIG. 1, according to an exemplary embodiment.

FIG. 3 is a block diagram of a control system of the door system of FIG. 1, according to an exemplary embodiment.

FIGS. 4 and 5 are perspective views of a deadbolt assembly of the door system of FIG. 1, according to an exemplary embodiment.

FIG. 6 is a side view of the deadbolt assembly of FIG. 4 installed on a door, according to an exemplary embodiment.

FIG. 7 is an exterior perspective view of the deadbolt assembly of FIG. 4 installed on the door of FIG. 6.

FIG. 8 is an interior perspective view of the deadbolt assembly of FIG. 4 installed on the door of FIG. 6.

FIG. 9 is an exterior perspective exploded view of the deadbolt assembly of FIG. 4 and the door of FIG. 6.

FIGS. 10 and 11 are interior perspective exploded views of the deadbolt assembly of FIG. 4 and the door of FIG. 6.

FIG. 12 is a perspective view of a battery clip of the deadbolt assembly of FIG. 4.

FIG. 13 is a perspective view of the deadbolt assembly of FIG. 4 assembled with an interactive unit of the door system of FIG. 1, according to an exemplary embodiment.

FIG. 14 is an exterior perspective view of the interactive unit of FIG. 13 installed on the door of FIG. 6.

FIG. 15 is an interior perspective exploded view of the deadbolt assembly of FIG. 4, the door of FIG. 6, and the interactive unit of FIG. 13.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a door assembly includes an integrated electronic deadbolt assembly. The deadbolt assembly is constructed from a series of modules or subassemblies that are coupled to one another. A lock subassembly is configured to receive a key to selectively permit locking and unlocking a deadbolt from an exterior side of the door. A thumb turn subassembly is configured to permit manually locking and unlocking the deadbolt from an interior side of the door. A motor subassembly is configured to lock and unlock the deadbolt in response to an electronic input. Beneficially, the deadbolt assembly can be retrofitted into the crossbore of a standard door. When assembled, only the thumb turn subassembly and the lock subassembly are visible. Accordingly, the deadbolt assembly may be visually indistinguishable from a purely mechanical deadbolt assembly. The thumb turn subassembly may include a battery that powers various systems of the deadbolt assembly. In response to conditions associated with a fire, the deadbolt assembly may automatically eject the battery away from the door to limit the impact of a potential battery fire on egress through the door.

### Overall Door System

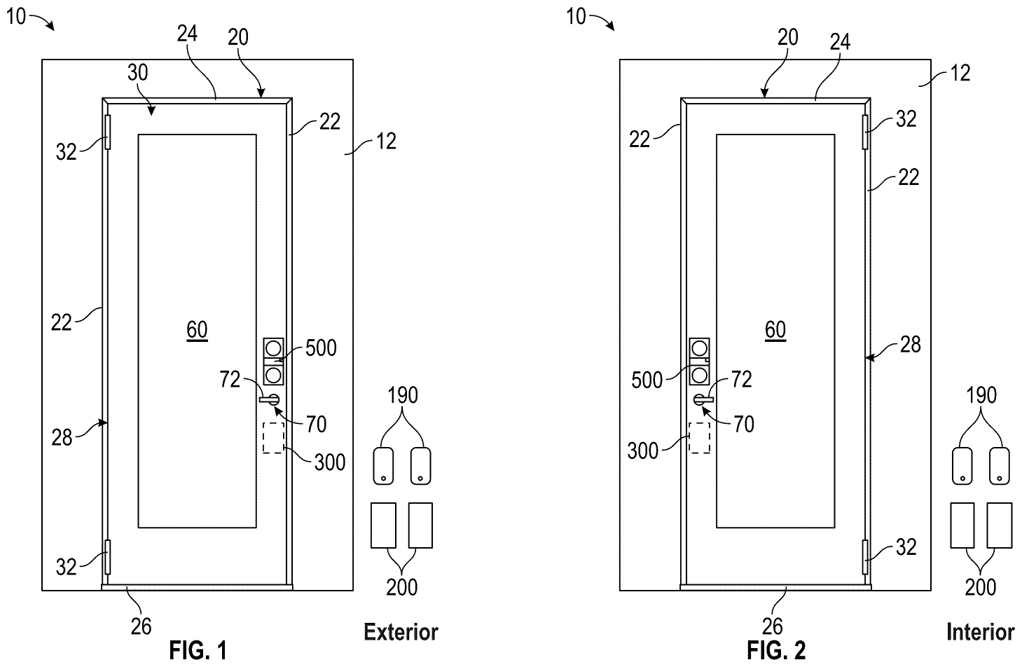

Referring to FIGS. 1 and 2, an electronic door system or electronic door assembly is shown as door system 10, according to an exemplary embodiment. The door system 10 may incorporate any structure, functionality, and/or features of the door system described in International Publication No. WO2024/006540, filed on Jun. 30, 2023, which is incorporated herein by reference in its entirety.

The door system 10 may facilitate selective access to a structure or building, such as a home, an apartment, a garage, or a commercial building, having one or more walls 12. While the door system 10 may be discussed herein as being used with a home, it should be understood that the door system 10 may alternatively be used with any other type of structure. By way of example, the door system 10 may prevent access to an interior of the structure by unauthorized users and permit access to the interior of the structure by authorized users (e.g., homeowners, residents, invited guests, etc.). The door system 10 may provide one or more electronic systems that facilitate control over access to the interior of the structure.

The door system 10 includes a stationary portion or door frame 20 coupled to or installed within the wall 12. The door frame 20 includes a series of frame sections, shown as side jambs 22, head jamb 24, and sill 26. The side jambs 22 extend substantially vertically and are laterally offset from one another. The head jamb 24 extends substantially horizontally between the top end portions of the side jambs 22. The sill 26 extends substantially horizontally between the bottom end portions of the side jambs 22. Together, the side jambs 22, the head jamb 24, and the sill 26 define a passage, aperture, or opening, shown as doorway 28 therebetween. The doorway 28 may be sized to facilitate the passage of one or more users through the doorway 28.

The door system 10 further includes a movable portion, body, door slab, or door leaf, shown as door 30. The door 30 is movably coupled to the door frame 20 by one or more hinges, shown as hinges 32. Specifically, the hinges 32 are each coupled to a side jamb 22 and to the door 30. As shown, the hinges 32 pivotally couple the door 30 to the door frame 20 such that the door is pivotable or rotatable about a substantially vertical axis. In other embodiments, the door 30 is otherwise movably coupled to the door frame 20 (e.g., slidably coupled).

The door 30 is selectively repositionable between (a) a blocking position, shut position, or closed position and (b) an unobstructed position or open position. In the closed position, the door 30 extends across the doorway 28, preventing movement of a user through the doorway 28. In the open position, the door 30 is moved out of the doorway 28, permitting movement of the user through the doorway 28. The door 30 may swing inward (e.g., into the structure) and/or outward (e.g., away from the structure). In some configurations, the door 30 is coupled to a first one of the side jambs 22. In other configurations, the door 30 is coupled to the other of the side jambs 22. In some embodiments, the door 30 can be coupled to either of the side jambs 22 according to a preference of the user. Accordingly, the door 30 can be configured as a right hand door or a left hand door.

In some embodiments, the door 30 is constructed using wood, such as engineered wood or hardwood. In some embodiments, the door 30 is constructed using another material, such as metal, plastic, or a composite material (e.g., fiberglass). The door 30 may be formed from a single material or a combination of materials. In some embodiments, the door 30 is formed from a subframe covered by one or more panels or skins. In other embodiments, the door 30 is formed from a single piece of material.

The door 30 further includes one or more panes of transparent material (e.g., glass, polycarbonate, etc.) or privacy windows, shown as window 60. As shown, the window 60 is positioned adjacent the center of the door 30, such that the window 60 is surrounded on the top, bottom, left, and right sides by the subframe 40. The window 60 provides a line of sight through the door 30. The window 60 may be held in place by (e.g., fixedly coupled to) the subframe 40, the exterior skin 50, and/or the interior skin 52. In some embodiments, the door 30 includes a single, uninterrupted window 60 (e.g., as shown in FIG. 1). In other embodiments, the door 30 includes multiple windows 60. In yet other embodiments, the window 60 is omitted.

Referring to FIGS. 1 and 2, the door 30 includes an interface assembly, lockset, or handle assembly, shown as handle assembly 70. The handle assembly 70 serves as an interface through with the user can control opening and closing of the door 30. The handle assembly 70 includes a pair of interfaces (e.g., handles, knobs, pulls, push plates, etc.), shown as handles 72, configured to interface with a hand of a user. Specifically, a first handle 72 is positioned on the exterior side of the door 30, and a second handle 72 is positioned on the interior side of the door. The user may apply a pushing or pulling force onto the handle 72 to move the door 30 toward the open position or the closed position, as desired.

In some embodiments, the handle assembly 70 includes a latch and/or secondary deadbolt that extends outward from the door 30 to be received within a corresponding pocket or pockets defined by the door frame 20 to hold the door 30 in the closed position and/or locked configuration. In some such embodiments, the latch may be retracted by moving (e.g., rotating) one or both of the handles 72 relative to the rest of the door 30 and/or the main deadbolt may be retracted by turning a deadbolt thumb turn. Once retracted, the door 30 may be moved out of the closed position (i.e., the door 30 may be opened). In some embodiments, components of the handle assembly 70 operate mechanically and/or electromechanically (e.g., the handle assembly 70 includes an electromechanical locking mechanism such as an electronic main deadbolt). In some embodiments, the handle assembly 70 can be operated by either handle 72.

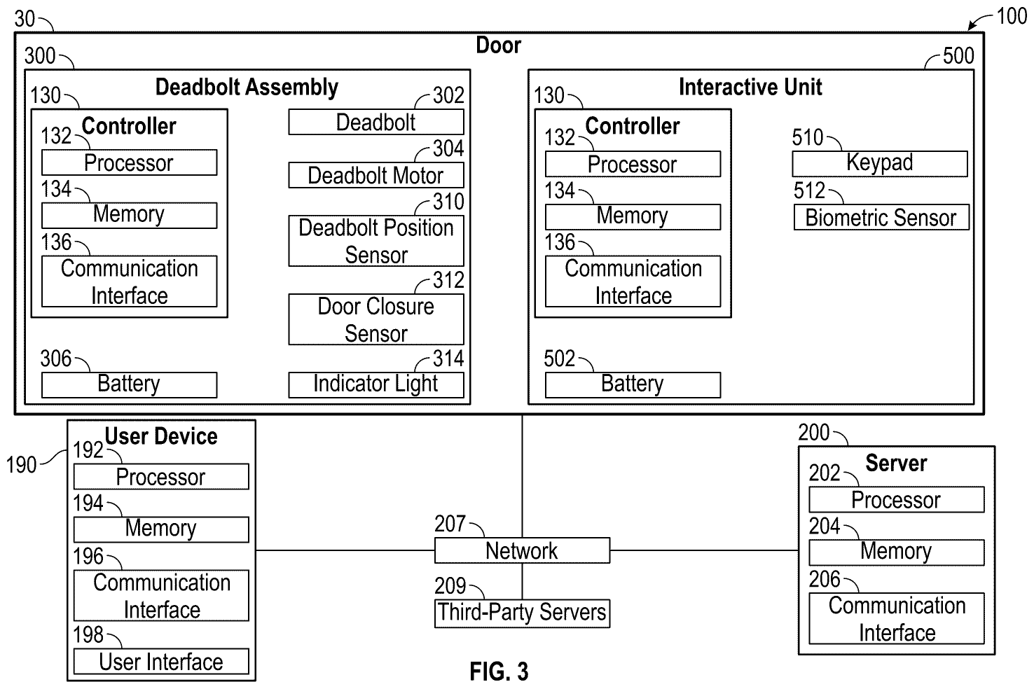

Referring to FIG. 3, the door system 10 includes an electronic control system or intelligent control system, shown as control system 100. The control system 100 may provide one or more features or functions that facilitate operation of the door system 10. The control system 100 may receive one or more inputs (e.g., sensor inputs, user commands, etc.) and provide one or more outputs (e.g., lights, sounds, movement of actuators, etc.). The control system 100 may provide certain features that are not available on other doors, such as remote operation, autonomous operation, and/or improved intrusion resistance, among other features.

As shown in FIG. 3, the door 30 includes a pair of controllers 130 that control operation of the door 30. The controllers 130 may operate together or separately to control the operation of the door 30. The controllers 130 each include a processing circuit, shown as processor 132, operatively coupled to a memory device, shown as memory 134. The memory 134 may store one or more instructions that are executed by the processor 132 to perform the processes described herein. The controller 130 includes a network interface or communication adapter, shown as communication interface 136. The communication interface 136 is configured to facilitate communication between the door 30 and the other components of the control system 100 (e.g., through the network 207). The communication interface 136 may be configured to perform wired and/or wireless configuration. By way of example, the communication interface 136 may communicate using NFC, RFID, BLE, Bluetooth, Wi-Fi, Zigbee, radio, over a cellular network, or through another communication protocol. In some embodiments, the communication interface 136 communicates according to the Matter standard. In some embodiments, the communication interface 136 communicates with AirBNB. The communication interface 136 may communicate directly with other devices or over a local area network or a wide area network (e.g., the Internet).

Referring to FIG. 3, the control system 100 may include one or more external devices that communicate with the door 30. The door 30 may communicate with the external devices directly or through a network 207 (e.g., a wired and/or wireless network, a local area network, a wide area network, a cellular network, etc.). In some embodiments, the control system 100 includes a network interface or access point (e.g., a router, etc.), that facilitates communication between the door 30 and the network 207. By way of example, the door 30 may be part of a local area network, and an access point may facilitate communication between the local area network and a wide area network (e.g., the Internet). In other embodiments, the door 30 communicates directly with the network 207, and the access point is omitted. By way of example, the network 207 may be a cellular network, and the door 30 may communicate directly with the network 207 (e.g., through a cellular receiver of the communication interface 136).

As shown in FIG. 3, the control system 100 may communicate with one or more user devices (e.g., smartphones, tablets, laptop computers, desktop computers, key fobs, etc.), shown as user devices 190. Each user device 190 may be associated with (e.g., owned by, registered to, etc.) one or more users. A user may utilize the user device 190 to issue commands to the control system 100 and/or review information provided by the control system 100.

Referring still to FIG. 3, the control system 100 may additionally or alternatively include one or more external computing units or remote systems, shown as server(s) 200. The server(s) 200 may be associated with a homeowner, a manufacturer of the door 30, and/or a third party service. The server(s) 200 may store information and/or perform processing to facilitate operation of the door system 10.

One or more of the servers 200 may be designated as third-party servers 209. The third-party servers 209 may be associated with (e.g., operated by) a third party. By way of example, the third party may be a service provider that offers Internet-based hosting services or cloud infrastructure. By way of example, the third-party servers 209 may be operated by Amazon Web Services, Google Cloud, Microsoft Azure, IBM Cloud, Oracle Cloud, or another cloud hosting service.

As shown in FIG. 3, each user device 190 includes a processing circuit, shown as processor 192, operatively coupled to a memory device, shown as memory 194. The memory 194 may store one or more instructions that are executed by the processor 192 to perform the processes described herein. The user device 190 further includes a network interface or communication adapter, shown as communication interface 196. The communication interface 196 is configured to facilitate communication between the user device 190 and the other components of the control system 100 (e.g., through the network 207). The communication interface 196 may be configured to perform wired and/or wireless configuration. By way of example, the communication interface 196 may communicate using near-field communication (NFC), radio-frequency identification (RFID), Bluetooth low energy (BLE), Bluetooth, Wi-Fi, Zigbee, over a cellular network, or through another communication protocol. The communication interface 196 may communicate directly with other devices or over a local area network or a wide area network (e.g., the Internet). The user device 190 includes a user interface 198, which communicates information to a user and/or receives information (e.g., commands) from the user. By way of example, the user interface 198 may include microphones, speakers, touchscreens, buttons, switches, knobs, or other input devices and/or output devices.

As shown in FIG. 3, each server 200 includes a processing circuit, shown as processor 202, operatively coupled to a memory device, shown as memory 204. The memory 204 may store one or more instructions that are executed by the processor 202 to perform the processes described herein. The server 200 further includes a network interface or communication adapter, shown as communication interface 206. The communication interface 206 is configured to facilitate communication between the server 200 and the other components of the control system 100 (e.g., through the network 207). The communication interface 206 may be configured to perform wired and/or wireless configuration. By way of example, the communication interface 206 may communicate using NFC, RFID, BLE, Bluetooth, Wi-Fi, Zigbee, over a cellular network, or through another communication protocol. The communication interface 206 may communicate directly with other devices or over a local area network or a wide area network (e.g., the Internet).

### Integrated Lock Assembly

Referring to FIG. 3, the door 30 further includes an integrated lock assembly, electronic lock, smart lock, or deadbolt, shown as deadbolt assembly 300. The deadbolt assembly 300 includes a lock member or shear member, shown as deadbolt 302, that is selectively repositionable to engage the door frame 20 and prevent movement of the door 30 out of the closed position (e.g., in addition to the deadbolt of the handle assembly 70, etc.). The deadbolt 302 may be manually actuated (e.g., by turning a key or knob). Additionally, the deadbolt assembly 300 includes an actuator, shown as deadbolt motor 304 (e.g., an electric motor) that is configured to reposition the deadbolt 302. In some embodiments, the handle assembly 70 is omitted, and the deadbolt assembly 300 is primarily or solely responsible for retaining the door 30 in the closed position.

The deadbolt assembly 300 further includes one or more energy storage devices, shown as battery 306, electrically coupled to the other components of the deadbolt assembly 300. The battery 306 may be configured to store energy (e.g., chemically) and provide electrical energy to power the various functions of the deadbolt assembly 300 (e.g., the controller 130, the deadbolt motor 304, etc.). In some embodiments, the battery 306 is sized to provide the energy required for between 9 months and 12 months of operation (e.g., 5 unlocking cycles per day, 3650 total electronic activations, etc.). The battery 306 may be rechargeable and/or replaceable. To facilitate this, the battery 306 may be removable (e.g., without the use of tools). In some embodiments, the battery 306 is a lithium-based battery. In other embodiments, the battery 306 is another type of energy storage device (e.g., a battery having another chemical composition, a capacitor, etc.). In yet other embodiments, the deadbolt assembly 300 is powered by an external power source (e.g., a connection to an electrical grid) and supplied with energy from outside of the door 30.

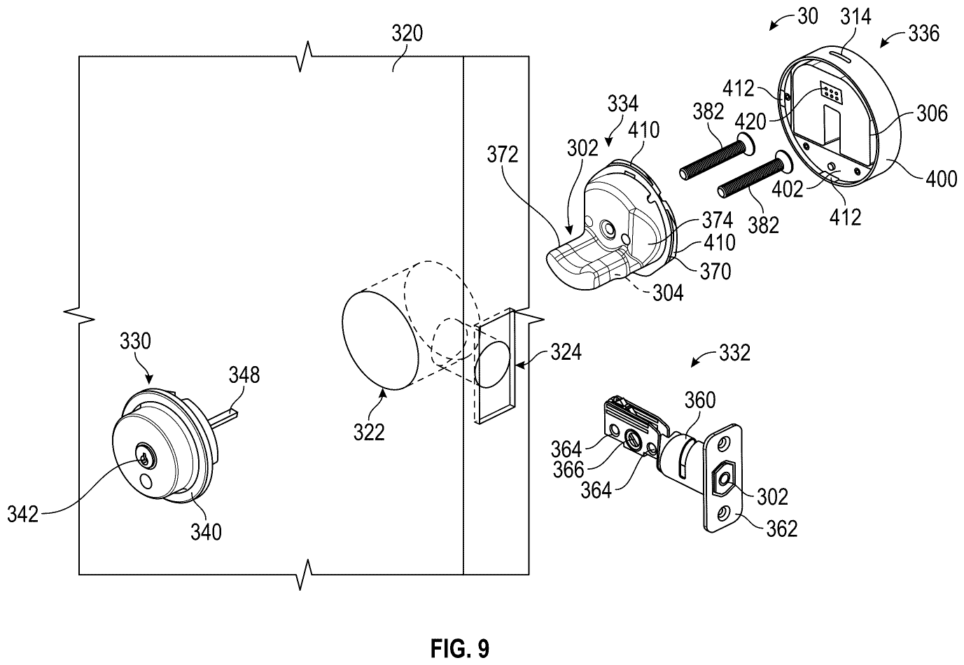

The deadbolt assembly 300 further includes a first sensor, shown as deadbolt position sensor 310, operatively coupled to the controller 130 of the deadbolt assembly 300. The deadbolt position sensor 310 is configured to supply sensor data indicating a current position of the deadbolt 302 (e.g., extended, retracted, partially extended, extended 0.5 inch, etc.). By way of example, the deadbolt position sensor 310 may include a rotational potentiometer coupled to the lock shaft 348 of FIG. 9, a linear potentiometer coupled to the deadbolt 302, or another type of sensor. The controller 130 may utilize the sensor data to perform closed-loop control over the position of the deadbolt 302. By way of example, the controller 130 may use the sensor data to determine when the deadbolt 302 is fully extended, and in response, command the deadbolt motor 304 to stop extending the deadbolt 302.

The deadbolt assembly 300 further includes a second sensor, shown as door closure sensor 312, operatively coupled to the controller 130 of the deadbolt assembly 300. The door closure sensor 312 is configured to supply sensor data indicating whether the door 30 is in the closed position. By way of example, the door closure sensor 312 may include a magnetometer, Hall effect sensor, or other magnetic sensor configured to sense a magnetic field. A permanent magnet may be fixedly coupled to the door frame 20. The permanent magnet and the door closure sensor 312 may be positioned such that the door closure sensor 312 senses the magnetic field of the permanent magnet only when the door 30 is in the closed position. The controller 130 may determine whether the door 30 is closed based on whether the door closure sensor 312 senses the magnetic field. In some embodiments, the controller 130 prevents extension of the deadbolt 302 by the deadbolt motor 304 unless the door closure sensor 312 indicates that the door 30 is in the closed position.

The deadbolt assembly 300 may further include a visual indicator, output device, or user interface, shown as indicator light 314. The indicator light 314 may consume electrical energy from the battery 306 and emit light as controlled by the controller 130. The indicator light 314 may communicate information to a user by varying colors, varying brightness, varying the frequency at which the indicator light 314 flashes, or turning on or off. Additionally or alternatively, the indicator light 314 may be or include a speaker that provides auditory notifications.

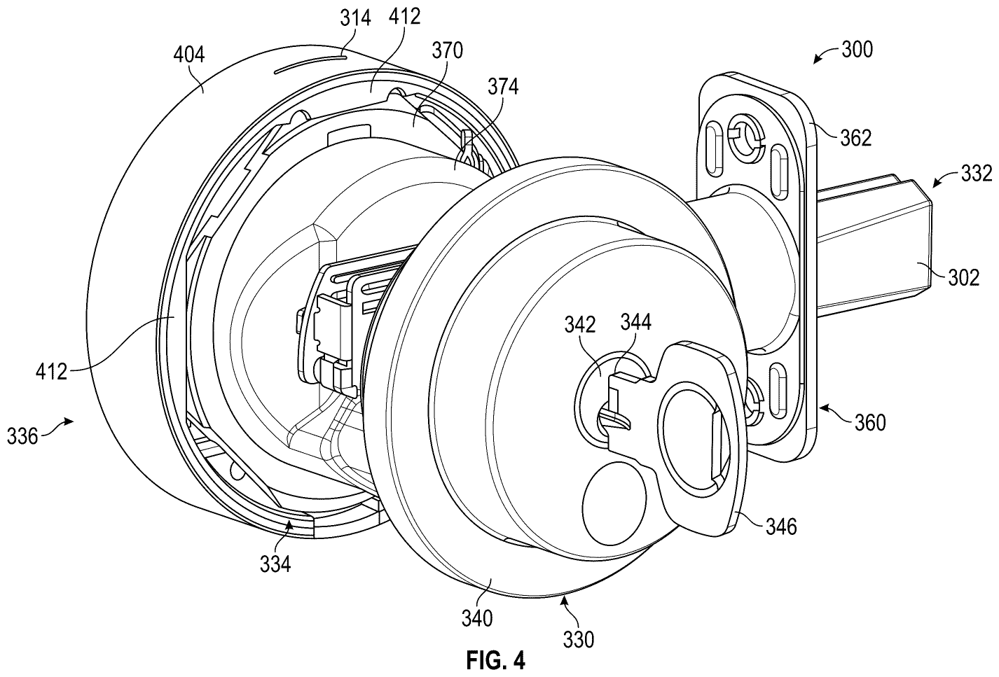

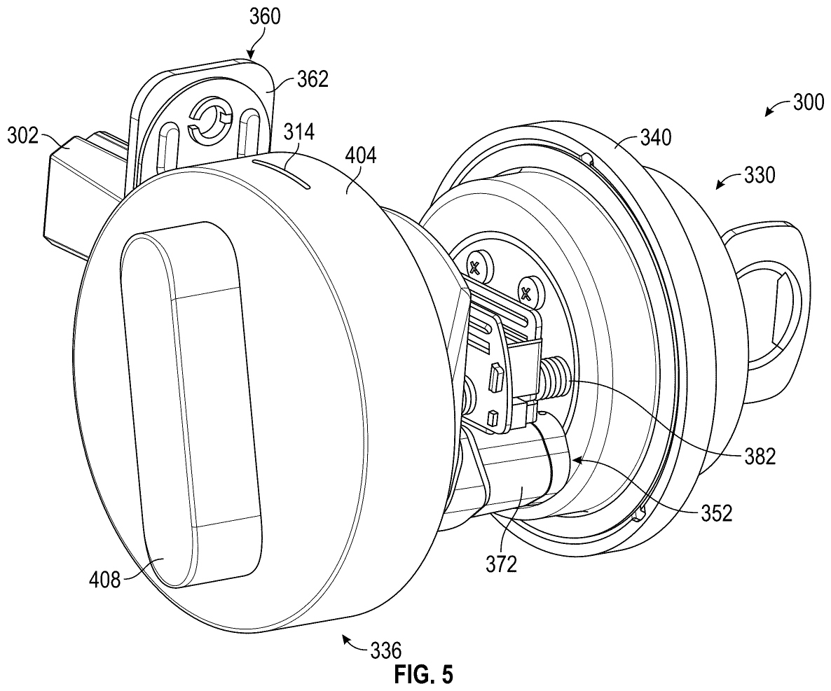

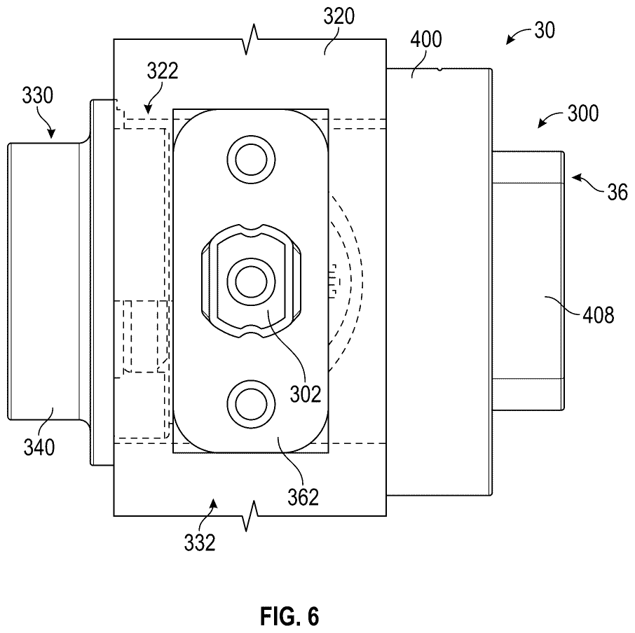

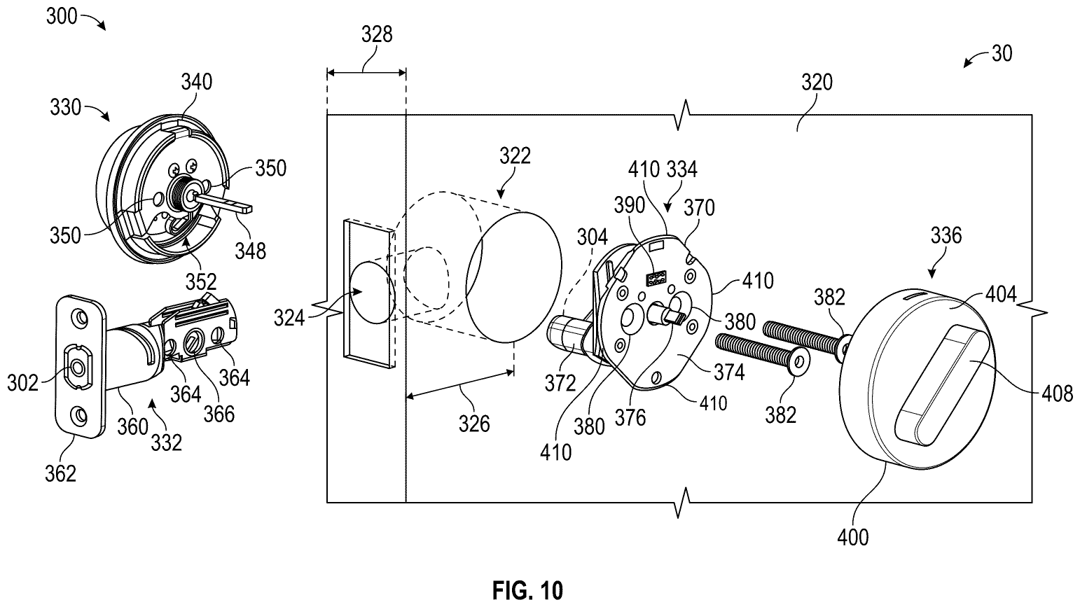

Referring to FIGS. 4-12, the deadbolt assembly 300 is shown according to an exemplary embodiment. In various figures, the deadbolt assembly 300 is shown coupled to a body, frame, or structure of the door 30, shown as slab 320. As shown in FIG. 10, the slab 320 defines a first aperture or passage, shown as crossbore 322, that extends longitudinally from an interior face of the slab 320 to an exterior face of the slab 320. A second aperture or passage (e.g., a latch bore or edge bore), shown as edge bore 324, extends laterally outward from the crossbore 322 to an edge of the slab 320. A center of the crossbore 322 is laterally offset from the edge of the door by a backset 326. The slab 320 has a thickness 328 measured longitudinally (e.g., along a length of the crossbore 322).

In some embodiments, the deadbolt assembly 300 is beneficially usable with a variety of different commercially available slabs 320 without modifying the crossbore 322 or the edge bore 324. This may facilitate utilizing the deadbolt assembly 300 to retrofit an existing door with the electronic lock functionality of the deadbolt assembly 300 described herein. By way of example, the deadbolt assembly 300 may be usable with a slab 320 having various standardized dimensions that are common in commercially-available doors. In some embodiments, the crossbore 322 has an approximately 2.125″ diameter (e.g., a standard crossbore diameter). In some embodiments, the edge bore 324 has an approximately 1″ diameter (e.g., a standard edge bore diameter). In some embodiments, the backset 326 is between about 2.375″ and about 2.75″ (e.g., a standard backset). In some embodiments, the thickness 328 is between about 1.75″ and about 2.25″. In some such embodiments, the thickness 328 is between about 1.75″ and about 2″. Accordingly, the deadbolt assembly 300 may be adjustable to accommodate multiple different backsets 326 and thicknesses 328 (e.g., without a door gasket).

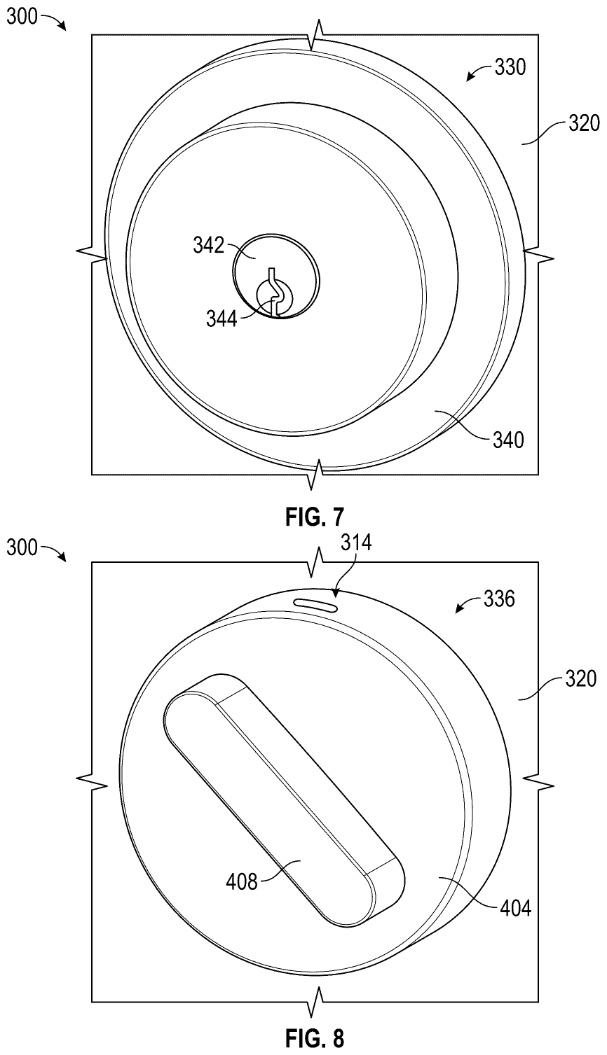

The deadbolt assembly 300 includes a variety of different sections, modules, or subassemblies that are coupled to one another to form the deadbolt assembly 300. Specifically, as shown in FIGS. 4-12, the deadbolt assembly 300 includes (a) a keyed subassembly or exterior subassembly, shown as lock subassembly 330, (b) a deadbolt subassembly 332, (c) an actuator or motive subassembly, shown as motor subassembly 334, and (d) an interface subassembly or interior subassembly, shown as thumb turn subassembly 336. As shown in FIG. 7, when installed in the door 30, the lock subassembly 330 is visible and accessible from an exterior side of the door 30. As shown in FIG. 8, when installed in the door 30, the thumb turn subassembly 336 is visible and accessible from an interior side of the door 30. The motor subassembly 334 is obscured from view by the lock subassembly 330 and the thumb turn subassembly 336, such that the motor subassembly 334 is not visible from an observer outside of the door 30.

As shown in FIGS. 4-7 and 9, the lock subassembly 330 includes a frame, chassis, or exterior escutcheon, shown as housing 340, fixedly coupled to the slab 320 and exposed to the exterior surroundings (e.g., an outdoor environment). The housing 340 may be made from metal, plastic, or another material. The housing 340 may extend at least partially into the crossbore 322. The housing 340 may seal against the slab 320 to prevent ingress of water or debris into the crossbore 322.

As shown in FIGS. 4, 7, and 9, a security device, shown as lock cylinder 342, is fixedly coupled to the housing 340 and extends into the housing 340. As shown, the lock cylinder 342 is flush with an outer surface of the housing 340. The lock cylinder 342 defines a passage, shown as keyway 344, that is sized and shaped to receive a physical authenticator, shown as key 346. The lock cylinder 342 may be a pin tumbler lock, a disc lock, or another type of locking system. In some embodiments, the lock cylinder 342 is constructed from metal (e.g., to resist forced entry). In response to receiving the key 346, the lock cylinder 342 is configured to rotate freely. The lock cylinder 342 may only be rotatable in response to receiving keys 346 having a known cutting pattern associated with an authenticated user (e.g., an owner of the home where the door 30 is installed).

As shown in FIGS. 9 and 10, a torque transfer member, shown a lock shaft 348, is coupled to the lock cylinder 342 and rotates with the lock cylinder 342. The lock shaft 348 extends into the crossbore 322 and engages the deadbolt subassembly 332 and the motor subassembly 334. In some embodiments, the lock shaft 348 has at least one flat surface (e.g., forming a D-shaft, a hexagonal shaft, a flat shaft, etc.) to facilitate transferring torque from the lock shaft 348 to another component.

As shown in FIG. 10, the housing 340 further defines a set of recesses or passages, shown as fastener apertures 350. The fastener apertures 350 extend into the housing 340 from an interior surface of the housing 340. In some embodiments, the fastener apertures 350 are threaded. As shown in FIGS. 5 and 10, the housing 340 further defines a recess or passage, shown as motor recess 352. The motor recess 352 is radially offset from the lock shaft 348. The motor recess 352 extends into the housing 340 from the interior surface of the housing 340.

Referring to FIGS. 4, 5, and 9-11, the deadbolt subassembly 332 includes the deadbolt 302 and a frame or chassis, shown as deadbolt housing 360. The deadbolt housing 360 receives the deadbolt 302 (e.g., in a telescoping arrangement), slidably coupling the deadbolt 302 to the deadbolt housing 360. Accordingly, the deadbolt 302 is laterally repositionable (e.g., to extend or retract). The deadbolt housing 360 extends into the edge bore 324. An end of the deadbolt housing 360 includes a flat portion, shown as latch plate 362, that is fixedly coupled to the edge of the slab 320 (e.g., by a pair of fasteners). In some embodiments, the deadbolt 302 is formed such that the portion of the deadbolt 302 within the latch plate 362 when the deadbolt 302 is fully extended is completely solid (e.g., completely continuous throughout). This may improve the security of the deadbolt assembly 300 (e.g., the resistance of the deadbolt 302 to shear when forced entry is attempted).

As shown in FIGS. 9 and 10, the deadbolt housing 360 defines a set of passages, shown as fastener apertures 364, that extend longitudinally through the deadbolt housing 360. The fastener apertures 364 each align with one of the fastener apertures 350. The deadbolt subassembly 332 further includes a coupler, shown as deadbolt linkage 366, that is received within the deadbolt housing 360 and coupled to the deadbolt 302. The deadbolt linkage 366 defines a passage that receives the lock shaft 348 therethrough, such that rotation of the lock shaft 348 causes a corresponding movement of the deadbolt 302.

As shown in FIGS. 9 and 10, the motor subassembly 334 is configured to be at least partially positioned within the crossbore 322 and covered on the interior and exterior ends by the thumb turn subassembly 336 and the lock subassembly 330, respectively (e.g., such that the motor subassembly 334 is not visible without disassembling the deadbolt assembly 300). The motor subassembly 334 includes a frame or chassis, shown as housing 370. The housing 370 includes a protrusion, shown as motor portion 372, that extends toward the lock subassembly 330. The motor portion 372 at least partially contains the deadbolt motor 304. In some embodiments, the housing 370 contains the controller 130.

The motor portion 372 is radially offset from the lock shaft 348 and is received within the motor recess 352 of the housing 340. Accordingly, the motor portion 372 may engage the housing 340 to limit rotation of the motor subassembly 334 relative to the lock subassembly 330 (e.g., to clock the motor subassembly 334 relative to the lock subassembly 330). Similarly, the motor portion 372 extends below the deadbolt housing 360 and engages the deadbolt housing 360. This engagement may limit rotation of the motor subassembly 334 relative to the deadbolt subassembly 332 (e.g., to clock the motor subassembly 334 relative to the deadbolt subassembly 332). The deadbolt housing 360 is directly fixedly coupled to the slab 320. Accordingly, the motor portion 372 clocks the motor subassembly 334 and the lock subassembly 330 relative to the slab 320 (e.g., to prevent the motor subassembly 334 and the lock subassembly 330 from spinning within the crossbore 322).

As shown in FIGS. 9 and 10, the motor subassembly 334 further includes a power transmission, shown as gearbox 374, positioned within or incorporated with the housing 370. The gearbox 374 couples an output shaft of the deadbolt motor 304 to the lock shaft 348 (e.g., through a gear train). In some embodiments, the gearbox 374 provides a gear reduction between the deadbolt motor 304 and the lock shaft 348. The gearbox 374 includes an output shaft 376 that engages with and rotationally fixedly couples to the lock shaft 348 and extends toward the thumb turn subassembly 336.

As shown in FIG. 10, the housing 370 defines a set of passages, shown as fastener apertures 380, that each extend longitudinally through the housing 370. The fastener apertures 380 each align with one of the fastener apertures 350 and one of the fastener apertures 364. As shown in FIGS. 9 and 10, the deadbolt assembly 300 includes a pair of fasteners, shown as bolts 382. Each bolt 382 extends through one of the fastener apertures 380, through one of the fastener apertures 364, and enters one of the fastener apertures 350. The bolts 382 may each have a head engaging the housing 370 and each have a threaded engagement with the fastener apertures 350, such that when the bolts 382 are tightened, the housing 370 is drawn toward the housing 340. Accordingly, the bolts 382 tighten the motor subassembly 334 and the lock subassembly 330 against opposing sides of the slab 320, fixedly coupling the deadbolt assembly 300 to the slab 320. In some embodiments, the fastener apertures 380 are countersunk to facilitate flush placement of the heads of the bolts 382 along a surface of the housing 370. The deadbolt assembly 300 may accommodate slabs 320 of different thicknesses 328 by varying the length of the bolts 382 and/or by varying how far the bolts 382 have been tightened.

As shown in FIG. 10, positioned along an exterior surface of the housing 370 is an electrical connector 390 including a series of electrical contacts (e.g., eight electrical contacts). The electrical connector 390 faces toward the thumb turn subassembly 336, such that the electrical contacts are exposed to the thumb turn subassembly 336. The electrical connector 390 is configured to electrically couple the controller 130, the deadbolt motor 304, and/or the battery 306.

As shown in FIGS. 4-6 and 8-12, the thumb turn subassembly 336 includes a housing 400 having a battery support, shown as base portion 402, and an exposed portion, shown as faceplate 404. The base portion 402 couples to the housing 370. The faceplate 404 is coupled to the base portion 402 and covers the base portion 402. The faceplate 404 is visible from the interior side of the door 30. The faceplate 404 defines a passage 406 that extends longitudinally through the faceplate 404 and receives the output shaft 376 of the gearbox 374. An interface element or lever, shown as thumb turn 408, is coupled to the output shaft 376, such that a rotation of the thumb turn 408 causes a corresponding rotation of the output shaft 376 and the lock shaft 348.

As shown in FIGS. 4, 9, and 10, the housing 370 includes a series of protrusions, shown as lobes 410, positioned along an interior side of the housing 370. The lobes 410 are positioned along an outer perimeter of the housing 370 and extend radially outward from the housing 370. The lobes 410 are angularly offset from one another (e.g., by 90 degrees), such that the lobes 410 are evenly spaced along the perimeter of the housing 370. The base portion 402 includes a series of clips or retainers, shown as clips 412, that are positioned along the exterior side of the base portion 402. The clips 412 are angularly offset from one another, having a similar angular spacing to the lobes 410. The clips 412 are each sized to engage or receive one of the lobes 410, such that the base portion 402 is coupled to the housing 370 when the clips 412 engage the lobes 410. To couple the base portion 402 to the housing 370, the base portion 402 may be moved toward the housing 370 with the lobes 410 positioned between the clips 412. The base portion 402 may then be rotated until the clips 412 engage the lobes 410, and the clips 412 hold the base portion 402 against the housing 370. After engagement with the lobes 410, the clips 412 may resist rotation of the base portion 402 to prevent removal of the base portion 402 from the housing 370.

In operation, the deadbolt 302 can be repositioned (e.g., engaged or disengaged) in several different ways, providing flexibility of use to the user. Regardless of how the deadbolt assembly 300 is actuated, the thumb turn 408 may rotate along with movement of the deadbolt 302. Accordingly, the rotational position of the thumb turn 408 may provide a visual indication of the state of the deadbolt assembly 300 (e.g., locked or unlocked).

To engage or disengage the deadbolt 302 from the exterior side of the door 30, a user may insert an authorized key 346 into the keyway 344 and turn the key 346 in a locking direction or an unlocking direction. In response, the lock cylinder 342 will rotate the lock shaft 348. Rotation of the lock shaft 348 then engages or disengages the deadbolt 302 through the deadbolt linkage 366.

To engage or disengage the deadbolt 302 from the interior side of the door 30, a user may apply a torque to the thumb turn 308. The thumb turn 308 may rotate the output shaft 376, which in turn rotates the lock shaft 348. Rotation of the lock shaft 348 then engages or disengages the deadbolt 302 through the deadbolt linkage 366. The thumb turn 308 may be operated without a key or credential, as the user must already have access to the home in order to be positioned on the interior side of the door 30 and able to reach the thumb turn 308.

To engage or disengage the deadbolt 302 electronically, a command is sent to the controller 130. The command may be authenticated through various processes. In response to a determination that the command is authentic or approved, the controller 130 may operate the deadbolt motor 304 to rotate the output shaft 376 of the gearbox 374. The output shaft 376 may rotate the lock shaft 348. Rotation of the lock shaft 348 then engages or disengages the deadbolt 302 through the deadbolt linkage 366.

As shown in FIGS. 9, 11, and 12, the housing 400 receives the battery 306. Specifically, the battery 306 is positioned between the base portion 402 and the faceplate 404. Positioned along a rear surface of the battery 306 is an electrical connector 420 including a series of electrical contacts (e.g., eight electrical contacts). The electrical connector 420 faces toward the motor subassembly 334, such that the electrical contacts are exposed to the motor subassembly 334. Specifically, the electrical connector 420 is positioned such that the electrical connector 420 engages the electrical connector 390 when the thumb turn subassembly 336 is coupled to the motor subassembly 334. During this engagement, the electrical contacts engage one another, electrically coupling the battery 306 to the deadbolt motor 304 and the controller 130 through the electrical connector 390 and the electrical connector 420. The electrical contacts permit the battery 306 to move freely away from the motor subassembly 334 (e.g., when the battery 306 is ejected). In some embodiments, the motor subassembly 334 is electrically coupled to the battery 306 without the use of wires (e.g., without any wires present in the deadbolt assembly 300, without any wires being visible unless the subassembly is taken apart, etc.).

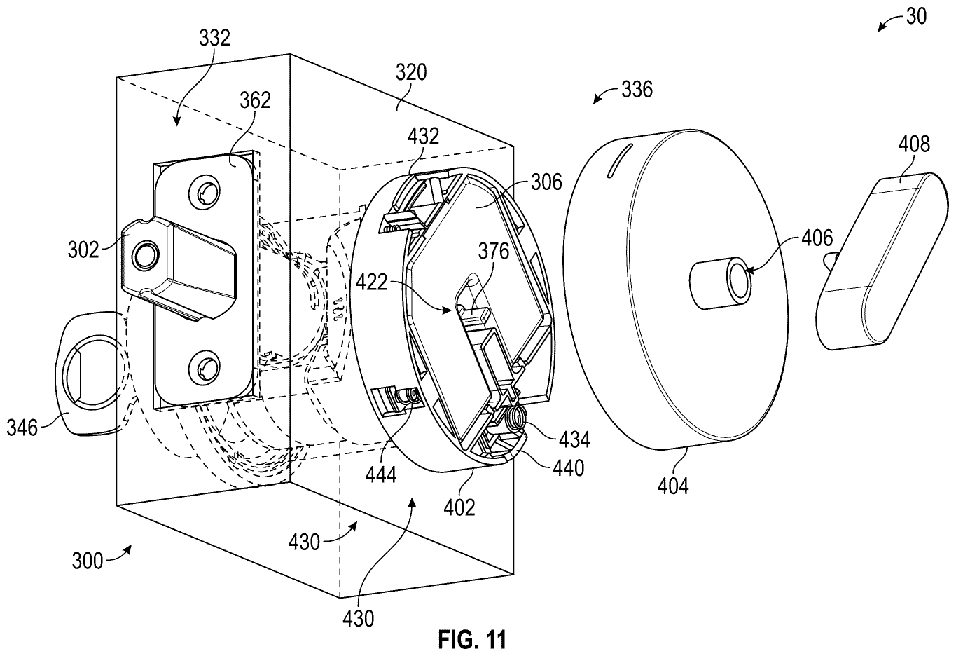

The battery 306 may be shaped to facilitate connection of the thumb turn 408 to the lock shaft 348. As shown in FIG. 11, the battery 306 defines a recess, shown as passage 422, through which the output shaft 376 extends. Accordingly, the output shaft 376 extends through the battery 306. The battery 306 may be c-shaped or u-shaped to form the passage 422. In other embodiments, the battery 306 is annular and surrounds the passage 422.

Referring to FIGS. 9 and 10, a process for installing and assembling the deadbolt assembly 300 is described. The deadbolt subassembly 332 is inserted laterally into the slab 320 through the edge bore 324, and the latch plate 362 is fixedly coupled to the slab 320 (e.g., by inserting screws through apertures of the latch plate 362 and into the slab 320). The lock subassembly 330 is inserted into the crossbore 322 from an exterior side of the slab 320, with the lock shaft 348 extending through the deadbolt linkage 366. The motor subassembly 334 is inserted from the interior side of the slab 320, and the end of the lock shaft 348 is engaged with (e.g., inserted into) the output shaft 376 of the gearbox 374, fixedly coupling the lock shaft 348 with the output shaft 376. The bolts 382 are inserted through the fastener apertures 380, 364, and 350 and tightened. By tightening the bolts 382, the lock subassembly 330 and the motor subassembly 334 are drawn towards one another, forcing the housing 340 against an exterior surface of the slab 320 and forcing the housing 370 against an interior surface of the slab 320. Accordingly, the bolts 382 fixedly couple the deadbolt assembly 300 to the slab 320. The housing 400 of the thumb turn subassembly 336 is fixedly coupled to the housing 370 (e.g., through one or more clips), with the output shaft 376 extending through the passage 422 of the battery 306 and the passage 406 of the faceplate 404. The thumb turn 408 is then coupled to the output shaft 376. The deadbolt assembly 300 is then fully installed and operable.

FIGS. 7 and 8 illustrate a fully assembled configuration of the deadbolt assembly 300 installed on a slab 320. As shown in FIG. 7, the lock cylinder 342 and the housing 340 of the lock subassembly 330 are visible from an exterior side of the door 30. As shown in FIG. 8, the faceplate 404 and the thumb turn 408 of the thumb turn subassembly 336 are visible from an interior side of the door 30. However, the components of the motor subassembly 334 and the battery 306 are not visible. Given that these electronic components are hidden, the deadbolt assembly 300 may be visually indistinguishable from a purely mechanical deadbolt assembly. This may be beneficial from an aesthetic standpoint, as some users may not find motors, batteries, controllers, or other electronic components visually appealing.

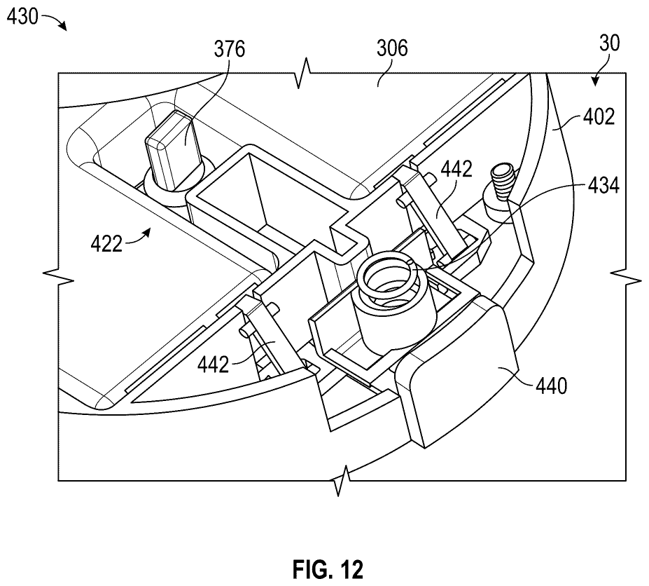

Referring to FIGS. 11 and 12, the deadbolt assembly 300 may include a battery expulsion, transfer, or transport assembly, shown as ejection assembly 430. The ejection assembly 430 may be configured to (a) selectively secure the battery 306, the base portion 402, and/or the faceplate 404 to the lock assembly 300 and (b) eject (e.g., throw, push) the battery 306, the base portion 402, and/or the faceplate 404 away from the door 30 in response to conditions indicative of a fire (e.g., high temperatures).

The ejection assembly 430 includes a first clip, retainer, or locking piece, shown as faceplate clip 432, and a second clip, retainer, or locking piece, shown as battery clip 440. The faceplate clip 432 and the battery clip 440 are coupled to the base portion 402 (e.g., at opposing ends thereof). The faceplate clip 432 engages the faceplate 404 (e.g., s recess of the faceplate 404) to releasably, removably, or selectively couple the faceplate 404 to the base portion 402. The battery clip 440 is coupled to the battery 306 by a pair of arms, levers, or clips, shown as battery retention arms 442. Together, the battery clip 440 and the spring 444 releasably, removably, or selectively couple the battery 306 to the base portion 402.

In some embodiments, the faceplate clip 432 is configured to deform (e.g., melt) in response to reaching a predetermined deformation temperature (e.g., a first threshold temperature). The deformation temperature may be less than deformation temperatures of the base portion 402 and/or the faceplate 404, such that the faceplate clip 432 deforms before the base portion 402 and the faceplate 404 in the event of a fire or other thermal event. A first biasing element, shown as spring 434, is coupled to the base portion 402 and/or the battery clip 440, and engages an inner surface of the faceplate 404. The spring 434 applies an outward biasing force onto the faceplate 404, and the faceplate clip 432 and the battery clip 440 hold the faceplate 404 in position. In response to the faceplate clip 432 reaching the deformation temperature, the faceplate clip 432 may deform and decouple the faceplate 404 from the base portion 402. The biasing force of the spring 434 may force the faceplate 404 outward, ejecting the faceplate 404 away from the door 30 and exposing the battery 306 and the base portion 402. To permit this movement, the thumb turn 408 may be slidably coupled to the output shaft 376, such that the spring 434 also disengages the thumb turn 408 from the output shaft 376.

The ejection assembly 430 includes a second biasing element, shown as spring 444. The spring 444 is coupled to the base portion 402 and engages the battery 306. The spring 444 applies an outward biasing force onto the battery 306. The housing 400 may further include one or more additional springs 444 coupled to the base portion 402 and/or the housing 370 and applying an outward force on the battery 306. By way of example, a spring 444 may be positioned between an interior face of the housing 370 and an exterior face of the battery 306.

According to an exemplary embodiment, the battery clip 440, the battery retention arms 442, and the spring 444 are configured to facilitate ejecting the battery 306 and/or the base portion 402 from the door 30 after the faceplate 404 is ejected. By way of example, the battery clip 440 may be retained by the faceplate 404, and the battery retention arms 442 may be retained in engagement with the battery 306 by the battery clip 440. For example, the battery clip 440 may be prevented from moving laterally outward through contact with an inner wall of the faceplate 404. The battery retention arms 442 may be held against the battery 306 by the battery clip 440, overcoming the outward force of the springs 444 and holding the battery 306 in place within the base portion 402. When the faceplate 404 is ejected from the base portion 402, the faceplate 404 moves away from the battery clip 440, permitting the battery clip 440 to move laterally outward. This releases the battery retention arms 442, which in turn release the battery 306. The springs 444 may then eject the battery 306 away from the base portion 402 and the door 30. In other embodiments, the battery clip 440 couples the base portion 402 to the housing 370, and the springs 444 eject both the base portion 402 and the battery 306 together. In yet other embodiments, the battery clip 440 melts or otherwise deforms to release the battery 306. The battery clip 440 deform at a higher temperature than the faceplate clip 432, such that the battery 306 is ejected after the faceplate 404.

### Interactive Unit

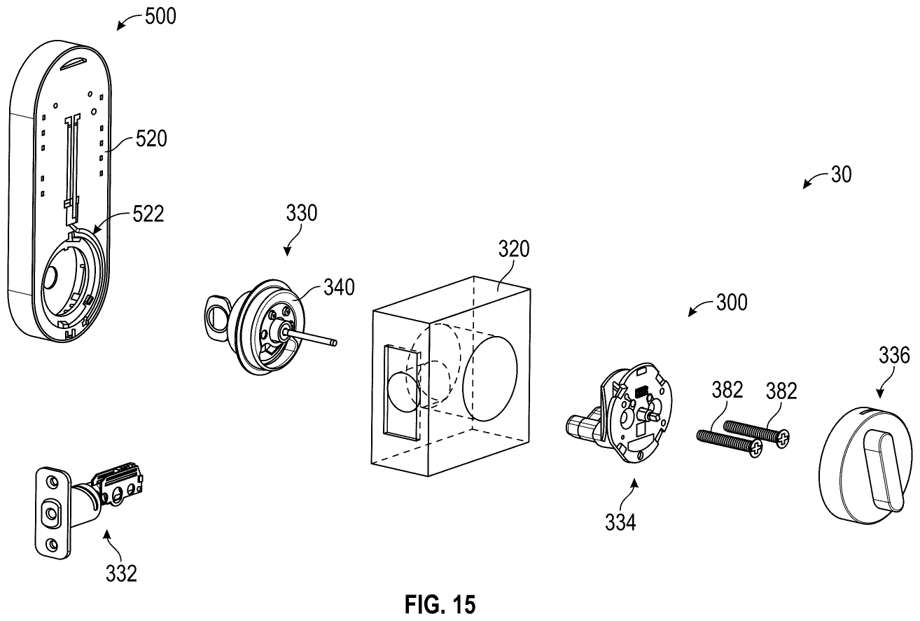

Referring to FIGS. 3 and 13-15, the door 30 further includes a user interface, operator interface, interface module, or interactive unit, shown as interactive unit 500. The interactive unit 500 may act as a user interface to provide information to a user or to receive information (e.g., commands) from a user. The interactive unit 500 may include one or more input devices (e.g., keypads, buttons, switches, knobs, pull cords, microphones, cameras, touch screens, etc.) that receive inputs from a user. The interactive unit 500 may include one or more output devices (e.g., speakers, displays, lights, buzzers, etc.) that provide information to a user.

As shown, the interactive unit 500 is coupled to the deadbolt assembly 300 and the exterior surface of the slab 320. In some embodiments, the interactive unit 500 is an optional assembly that can be added or removed as desired. By way of example, the deadbolt assembly 300 may be operable with or without the interactive unit 500, and the interactive unit 500 may be removably coupled to the deadbolt assembly 300 and the slab 320.

As shown in FIG. 3, the interactive unit 500 includes a controller 130 (e.g., separate from the controller 130 of the deadbolt assembly 300) that controls operation of the interactive unit 500. The interactive unit 500 also includes an energy storage device, shown as battery 502, that supplies electrical energy to power the functions of the interactive unit 500. In some embodiments, the interactive unit 500 is electrically isolated from the deadbolt assembly 300. By way of example, the communication interfaces 136 may permit wireless communication between the controllers 130 (e.g., via Bluetooth). The controller 130 of the interactive unit 500 may communicate with the network 207 directly or through the controller 130 of the deadbolt assembly 300. The battery 306 may be separate from (e.g., electrically isolated from) the battery 502. This isolated arrangement may facilitate removal of the interactive unit 500 without impacting operation of the deadbolt assembly 300. In other embodiments, the deadbolt assembly 300 and the interactive unit 500 share a battery and/or a controller.

As shown in FIGS. 3, 13, and 14, the interactive unit 500 includes a first input device, shown as keypad 510. The keypad 510 may include an array of buttons or touch interface providing buttons, each associated with a different character (e.g., number or letter). By monitoring which of the buttons are pressed and in which order, the keypad 510 may be configured to receive codes or passphrases to facilitate authenticating a user (e.g., prior to permitting the user to control the deadbolt assembly 300).

As shown in FIGS. 3, 13, and 14, the interactive unit 500 includes a second input device, shown as biometric sensor 512. The biometric sensor 512 may be configured to receive a biometric input from a user. By way of example, the biometric sensor 512 may include a fingerprint scanner configured to receive image data showing a fingerprint of the user. By way of another example, the biometric sensor 512 may include a camera or three-dimensional imaging device (e.g., a LIDAR sensor) configured to capture an image of a face of a user. The controller 130 may compare the biometric input to a database of biometric inputs associated with authenticated users to identify the user and determine if they should be authenticated (e.g., prior to permitting the user to control the deadbolt assembly 300).

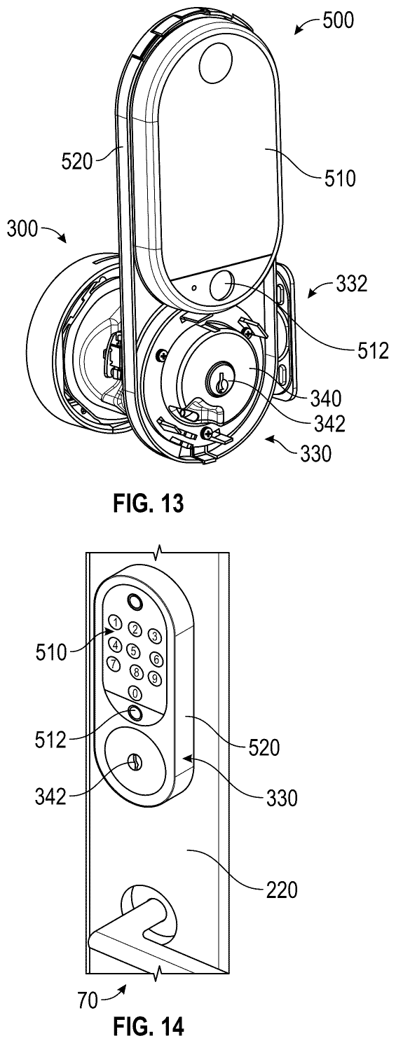

As shown in FIGS. 13-15, the interactive unit 500 includes a frame or support structure (e.g., an interface housing), shown as housing 520. The housing 520 contains and supports the controller 130, the battery 502, the keypad 510, and the biometric sensor 512. Accordingly, the interactive unit 500 may be a self-contained assembly. In some embodiments, the housing 520 is sealed to prevent ingress of contaminants (e.g., water, dust, etc.) that might otherwise damage components of the interactive unit 150.

The housing 520 defines an aperture, passage, or recess, shown as deadbolt recess 522. The deadbolt recess 522 extends longitudinally into the housing 520 from a rear side of the housing 520 and receives the housing 340 of the deadbolt assembly 300. Once the housing 340 is received within the deadbolt recess 522, the housing 520 may cover the housing 340 except for the lock cylinder 342. This may permit access to the keyway 344 while maintaining a continuous exterior aesthetic.

The housing 520 may be fixedly coupled to the housing 340 to limit or prevent movement of the interactive unit 500 relative to the deadbolt assembly 300. In some embodiments, the housing 520 is removably coupled to the housing 340 (e.g., with clips or fasteners). By way of example, the interactive unit 500 may be sold or otherwise provided as a kit including a tool that facilitates coupling or decoupling the housing 520 with the housing 340. Accordingly, the interactive unit 500 can be added or removed from the deadbolt assembly 300 as desired. In other embodiments, the interactive unit 500 is positioned separately from the deadbolt assembly 300 (e.g., at another location on the door 30, on the wall 12, etc.).

### Control System Operation

The controller 130 of the deadbolt assembly 300 may be configured to control the deadbolt motor 304 to reposition (e.g., engage, disengage, lock, unlock, etc.) the deadbolt 302 in response to various inputs or control logic. In some embodiments, the controller 130 of the deadbolt assembly 300 determines whether to lock or unlock the deadbolt 302 locally (e.g., based on a predetermined time of day). In some embodiments, the controller 130 of the deadbolt assembly 300 determines whether to lock or unlock the deadbolt 302 based on communications with the controller 130 of the interactive unit 500 (e.g., in response to receiving a credential through the keypad 510). In some embodiments, the controller 130 of the deadbolt assembly 300 determines whether to lock or unlock the deadbolt 302 based on communications with a user device 190, a server 200, and/or a third-party server 209.

In some embodiments, the controller 130 of the deadbolt assembly 300 determines whether to lock or unlock the deadbolt 302 based on information available locally. By way of example, the controller 130 may automatically lock or unlock the deadbolt assembly 300 according to a predetermined schedule (e.g., provided by a user device 190). By way of another example, the controller 130 may automatically lock the deadbolt assembly 300 when a predetermined period of time has elapsed since the last unlocking event. By way of another example, the controller 130 may prevent the deadbolt motor 304 from locking the deadbolt assembly 300 if the door closure sensor 312 indicates that the door 30 is open.

In some embodiments, the controller 130 of the deadbolt assembly 300 determines whether to lock or unlock the deadbolt 302 in response to authenticating a user. The controller 130 may receive an authentication credential (e.g., a code, a biometric input, etc.). The controller 130 may compare a provided authentication credential to a predetermined list of recognized authentication credentials (e.g., stored locally, on a server 200, etc.). The predetermined list may associate credentials with specific users. In some such embodiments, different users are provided with different access permissions. Some users are provided with permanent access. Some users are designated as guest users having access for only a predetermined period of time. Some users are provided with access at specific recurring times (e.g., days of the week, times of day, etc.). Access for specific users may be revoked (e.g., by an administrator through a user device 190).

In some embodiments, the authentication credential is a code (e.g., provided through the keypad 510). The controller 130 may support 25 or more codes as recognized authentication credentials. In some embodiments, the authentication credential is a biometric input (e.g., provided through the biometric sensor 512). The controller 130 may temporarily limit access if greater than a threshold number of unauthorized credentials are received within a threshold time period.

In some embodiments, the controller 130 of the deadbolt assembly 300 determines whether to lock or unlock the deadbolt 302 based on a user input from a user device 190. By way of example, a user may log into a user device 190 (e.g., through a web browser or application, over Bluetooth, etc.). In some embodiments, a portion of the deadbolt assembly 300 and/or the interactive unit 500 includes or displays a visual indicator (e.g., a QR code or bar code) that, when captured by a camera of the user device 190, directs the user device to a web portal for logging in. Additionally or alternatively, the user device 190 may be provided with a key that identifies the device. While logged in and during a period when the user has access, the user may remotely control the deadbolt assembly 300. By way of example, the user may provide a manual command to lock or unlock the deadbolt assembly 300. By way of another example, the deadbolt assembly 300 may automatically unlock in response to the user device 190 being in proximity (e.g., in wireless communication range). The controller 130 may supply information to a user device 190 for review by a user (e.g., through an app or web browser, in an email or text message, etc.).

In some embodiments, the controller 130 of the deadbolt assembly 300 determines whether to lock or unlock the deadbolt 302 based on a command from a third-party server 209. By way of example, the resident may provide a third-party server 209 associated with a delivery service with permissions to remotely operate the deadbolt 302. The third-party server 209 may predict when a delivery will occur (e.g., based on a predetermined schedule, based on a real-time location of a delivery vehicle, based on an input from delivery personnel). The third-party server 209 may send a signal to the controller 130 commanding the deadbolt 302 to unlock when the delivery is predicted to occur.

The controller 130 may provide diagnostic information regarding the deadbolt assembly 300 and/or the interactive unit 500 to a user device 190 and/or a server 200 (e.g., directly or over the network 207). By way of example, the controller 130 may send a current charge level of the battery 306, a detected position of the deadbolt 302 (e.g., from the deadbolt position sensor 310), whether the deadbolt 302 is repositioned manually or electronically, which user activated the deadbolt assembly 300, what type of credential was used to activate the deadbolt assembly 300, a connection strength of the communication interface 136 (e.g., a data transfer rate), a connection status of the communication interface 136 (e.g., which devices are in communication), whether the door 30 is opened or closed (e.g., based on information from the door closure sensor 312), whether the deadbolt 302 is jammed (e.g., based on information from the deadbolt position sensor 310), software versions, firmware versions, hardware versions, product serial numbers, or other information. The diagnostic information may be requested by a user or automatically pushed to a user (e.g., as a notification).

The controller 130 may wirelessly receive over-the-air software updates (e.g., from a server 200 or user device 190). The updates may automatically execute whenever available. The controller 130 may be resettable to factory default settings (e.g., in response to a predetermined interaction with a button within the deadbolt assembly 300).

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the door system 10 and as shown in the various exemplary embodiments are illustrative only. Additionally, any element disclosed in one embodiment may be incorporated or utilized with any other embodiment disclosed herein.

1. A deadbolt assembly for a door defining a crossbore extending from a first face of the door to a second face of the door, the deadbolt assembly comprising:
a deadbolt configured to engage a door frame to limit movement of the door;
a lock assembly including a first housing and a lock cylinder configured to be coupled to the deadbolt, the first housing defining a first fastener aperture;
a motor assembly including a second housing at least partially containing an electric motor configured to be coupled to the deadbolt, the second housing defining a second fastener aperture; and
a fastener configured to extend into the first fastener aperture and the second fastener aperture to both (a) force the first housing against the first face of the door and (b) force the second housing against the second face of the door.

2. The deadbolt assembly of claim 1, further comprising a thumb turn assembly including:
a cover configured to be coupled to the second housing of the motor assembly; and
a lever configured to be pivotably coupled to the cover and coupled to the deadbolt, wherein the lever is configured to be rotated by a user to reposition the deadbolt.

3. The deadbolt assembly of claim 2, wherein the first housing of the lock assembly and the cover are configured to obscure the second housing of the motor assembly from view when the deadbolt assembly is installed on the door.

4. The deadbolt assembly of claim 2, further comprising a battery configured to supply electrical energy to the electric motor, wherein the battery is configured to be received between the second housing of the motor assembly and the cover.

5. The deadbolt assembly of claim 4, wherein the battery is configured to extend between a head of the fastener and the cover.

6. The deadbolt assembly of claim 4, further comprising:
a clip configured to releasably couple the battery to the second housing of the motor assembly; and
a spring configured to eject the battery away from the door when the clip releases the battery from the second housing.

7. The deadbolt assembly of claim 6, wherein the clip is a first clip and the spring is a first spring, further comprising:
a second clip configured to releasably couple the cover to the second housing of the motor assembly; and
a second spring configured to eject the cover away from the door when the second clip releases the cover from the second housing.

8. The deadbolt assembly of claim 7, wherein the second clip is configured to release the cover from the second housing in response to reaching a threshold temperature.

9. The deadbolt assembly of claim 1, wherein the first housing and the second housing are each configured to extend into the crossbore.

10. The deadbolt assembly of claim 9, wherein the crossbore has a diameter of approximately 2.125 inches.

11. The deadbolt assembly of claim 1, wherein the first housing of the lock assembly defines a recess, and wherein the second housing of the motor assembly is configured to be received within the recess of the first housing.

12. The deadbolt assembly of claim 1, further comprising:
a linkage coupled to the deadbolt; and
a shaft configured to be coupled to the lock assembly and the motor assembly and configured to extend through the deadbolt,
wherein the linkage is configured to reposition the deadbolt in response to rotation of the linkage.

13. The deadbolt assembly of claim 12, wherein the shaft is a first shaft, further comprising a lever configured to be rotated by a user, wherein the motor assembly includes a second shaft coupling the lever to the first shaft, and wherein the first shaft is aligned with the second shaft.

14. The deadbolt assembly of claim 1, further comprising:
a shaft;
a linkage configured to reposition the deadbolt in response to rotation of the shaft; and
a battery configured to supply electrical energy to the electric motor, wherein the battery defines a passage that is configured to receive the shaft therethrough.

15. The deadbolt assembly of claim 1, further comprising a user interface including:
an input device configured to receive an input from a user; and
an interface housing coupled to the input device and defining an aperture configured to receive the lock assembly.

16. The deadbolt assembly of claim 15, wherein the input device includes at least one of a keypad configured to receive a code as the input from the user or a biometric sensor configured to receive a biometric input as the input from the user.

17. A deadbolt assembly for a door, the deadbolt assembly comprising:
a deadbolt;
a lock assembly including a first housing and a lock cylinder;
a motor assembly including a second housing at least partially containing an electric motor;
a shaft configured to couple the lock assembly and the motor assembly to the deadbolt;
a thumb turn assembly including a cover configured to be coupled to the motor assembly and a lever configured to be coupled to the shaft; and
a battery configured to extend between the second housing of the motor assembly and the cover and configured to supply electrical energy to the electric motor.

18. The deadbolt assembly of claim 17, wherein the lock assembly and the motor assembly are configured to be inserted into a crossbore of the door, and wherein the first housing and the cover are configured to obscure the second housing from view when the deadbolt assembly is installed on the door.

19. The deadbolt assembly of claim 17, further comprising a clip configured to releasably couple the cover to the second housing of the motor assembly, wherein the clip is configured to release the cover from the second housing in in response to reaching a threshold temperature.

20. A door assembly comprising:
a door having a first face, a second face opposite the first face, and a crossbore extending from the first face to the second face, wherein the crossbore has a diameter of approximately 2.125 inches;
a deadbolt slidably coupled to the door;
a deadbolt linkage coupled to the deadbolt and configured to reposition the deadbolt relative to the door;
a lock assembly including a first housing engaging the first face of the door and a lock cylinder coupled to the first housing, the first housing defining a first fastener aperture;
a motor assembly including a second housing engaging the second face of the door and an electric motor coupled to the second housing, the second housing defining a second fastener aperture, wherein the motor assembly extends into the crossbore of the door;
a fastener extending through the first fastener aperture and the second fastener aperture and coupling the first housing to the second housing;
a cover coupled to the second housing of the motor assembly;
a lever pivotably coupled to the cover;
a shaft coupling the lock cylinder, the electric motor, and the lever to the deadbolt linkage; and
a battery extending between the second housing of the motor assembly and the cover and configured to supply electrical energy to the electric motor.
